(19) United States
(12) Patent Application Publication
(10) Pub. No.: US 2013/0257270 A1
(43) Pub. Date: Oct. 3, 2013

(54) PLASMA LAMP IGNITION SOURCE

(71) Applicant: NANOMETRICS INCORPORATED, Milpitas, CA (US)

(72) Inventor: Ronald A. Rojeski, Campbell, CA (US)

(73) Assignee: Nanometrics Incorporated, Milpitas, CA (US)

(21) Appl. No.: 13/836,852

(22) Filed: Mar. 15, 2013

Related U.S. Application Data
(60) Provisional application No. 61/619,778, filed on Apr. 3, 2012.

(51) Int. Cl. H01J 61/12; H01J 61/16

(52) U.S. Cl. CPC H01J 61/12; H01J 61/16; B82Y 99/00
USPC 315/51; 977/932

(57) ABSTRACT

A plasma lamp includes a capsule with a gas contained within the capsule and an ignition source to ionize the gas to produce a light emitting plasma. The ignition source includes field defining conductors within the capsule and a radio frequency source external to the capsule. The radio frequency source and the field defining conductors are configured so that the field defining conductors will produce electric fields in response to RF energy from the radio frequency source and the electric field ionizes at least a portion of the gas.

### CROSS-REFERENCE TO RELATED APPLICATION(S)

This application claims priority under 35 USC 119 to U.S. Provisional Application No. 61/619,778, filed Apr. 3, 2012, and entitled “Plasma Lamp Ignition Source” which is incorporated herein by reference in its entirety.

### FIELD OF THE INVENTION

The present invention is related to generating light and more particularly to plasma lamps.

### BACKGROUND

High density plasma lamps may be used as a source of bright, broadband light. Conventional high density plasma lamps typically rely on a plasma of a low partial pressure noble gas (<0.5 bar) to vaporize metal salts that create a bright source of broadband light. The ignition process can be initiated by coupling radio frequency (RF) energy into the interior of the enclosure. The power density of the coupled RF energy must be sufficient to ionize the low pressure noble gas. The ionized species is accelerated within the RF field causing heating, evaporation, and ionization of the metal salt. The ionization of the primary gas creates further species of ionized gases until a final ignition of a sustained plasma of the primary gas plus evaporated metal halide is achieved.

### SUMMARY

A plasma lamp includes a capsule with a gas contained within the capsule and an ignition source to ionize the gas to produce a light emitting plasma. The ignition source includes field defining conductors within the capsule and a radio frequency source external to the capsule. The radio frequency source and the field defining conductors are configured so that the field defining conductors will produce electric fields in response to RF energy from the radio frequency source and the electric field ionizes at least a portion of the gas.

### BRIEF DESCRIPTION OF THE DRAWINGS

FIG. 1 illustrates a cross-sectional view of a plasma lamp with an ignition source that includes a plurality of field defining conductors.

FIG. 2 illustrates the plasma lamp with an initial pulse of RF energy from the RF source that is directed into the capsule.

FIG. 3 illustrates the plasma lamp with a sustained plasma in the capsule that produces light.

FIG. 4 graphically illustrates possible light output from a plasma lamp.

FIG. 5 is a flow chart of a method of producing a light emitting plasma in a plasma lamp.

FIG. 6 illustrates a cross-sectional view of another embodiment of a plasma lamp with an ignition source that includes a plurality of field defining conductors and metal salts.

### DETAILED DESCRIPTION

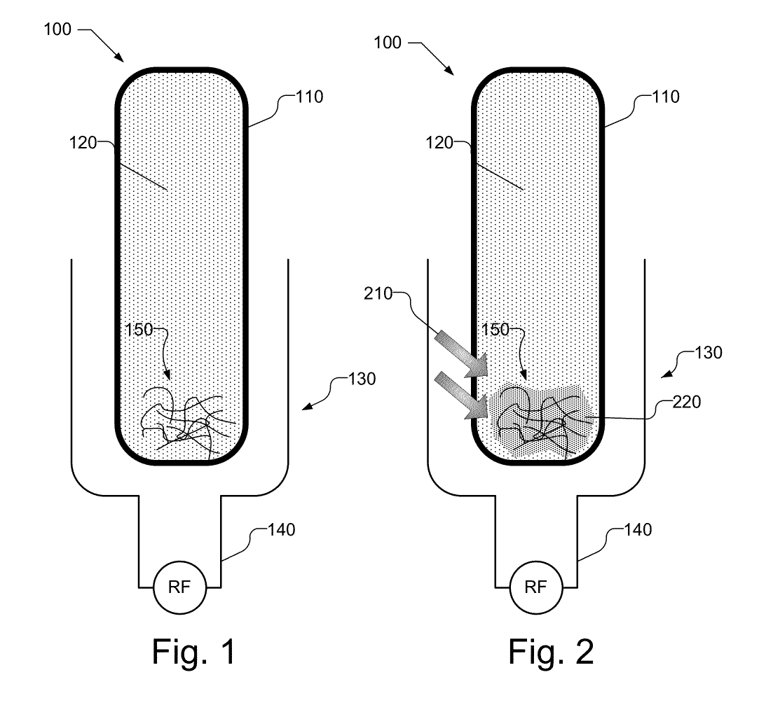

FIG. 1 illustrates a cross-sectional view of a plasma lamp 100 with an ignition source that includes a plurality of field defining conductors. The plasma lamp 100 includes a capsule 110 that contains a gaseous atmosphere 120. The capsule 110 may be, e.g., made of quartz or other suitable material, and is generally transmissive of photons in the range of, e.g., 150 nm to 2000 nm. The gaseous atmosphere 120 includes noble gases or noble gas halides and, by way of example, may include helium (He), neon (Ne), argon (Ar), Krypton (Kr), or xenon (Xe), and by further example, may include, e.g., ArF, KrCl, KrF, XeBr, XeCl, or XeF, or some combinations thereof. The pressure for the gaseous atmosphere 120 may be, e.g., 0.1 bar, 0.5 bar, 1 bar, 2 bar, 5 bar, 10 bar, 20 bar, or 40 bar, 80 bar, 120 bar, or possibly higher if desired, and may be sufficiently high to produce dimer molecules of pure noble gases, e.g., Xe₂, Kr₂, or Ar₂, when excited with RF energy. It should be understood that the pressure may further increase due to temperature increase once radio frequency (RF) energy is applied.

An issue that exists with conventional plasma lamps is that metal halides, by their nature, have low photon throughput in the ultra-violet (UV) and deep UV (DUV) region of the spectra, as the photons with UV/DUV wavelengths created within the plasma are also reabsorbed by the plasma. Thus, the use of ionized metal halide salts in conventional plasma lamps limits the lower wavelengths of light that may be emitted by the plasma lamps to wavelengths greater than UV, e.g., greater than 350 nm. Thus, in order to produce light with wavelengths in the UV and/or DUV regions, a plasma lamp should not include metal salts. The absences of metal salts in plasma lamps, however, requires the ignition of a plasma gas at higher pressures, e.g., greater than 0.5 bar, which is difficult to achieve. For example, ionization of a high pressure primary gas such as xenon requires a high electrical field making a high pressure xenon plasma lamp impractical. Moreover, while a plasma lamp may use low pressure gas for ignition at a more practical electrical field, low pressure gas does not produce a light with a continuum of spectra. Thus, the use of ionized metal salts or low pressure gas in conventional plasma lamps limits the useful spectra of light that is produced.

Plasma lamp 100 overcomes the issues of limited UV wavelengths of light by eliminating the metal salts and using an ignition source 130 that includes a radio frequency (RF) source 140 external to the capsule 110 and a plurality of field defining conductors 150 within the capsule 110. With the use of the field defining conductors 150 within the capsule 110, the gas may be easily ignited despite being held at high pressure, e.g., greater than 0.5 bar. The RF source 140 and the field defining conductors 150 are configured so that the interaction between the RF energy from the RF source 140 and the field defining conductors 150 will create a localized high electric field that ionizes at least a portion of the gas in the gaseous environment 120, i.e., the gas that is in the vicinity of the field defining conductors 150 is ionized. The field defining conductors 150 are electrical conductors that include a radius of curvature that is small enough and of sufficiently small area that a large localized electric field is generated from the interaction with the RF energy from the RF source 140.

By way of example, the field defining conductors 150 may be filamentary conductors or thin planar conductive sheets. An example of a filamentary conductor that may be used as the field defining conductors 150 is a carbon nano-tube bundle or carbon nano-fibers. Carbon nano-tubes, for example, may be single or multi-walled and may have a diameter of e.g., 1 nm, 3 nm, 7 nm, 15 nm, 30 nm, 60 nm, 120 nm, 200 nm, or possibly larger. The carbon nano-tubes may have lengths of e.g., 1 um, 3 um, 7 um, 15 um, 30 um, 60 um, 120 um, 200 um, or possibly longer. The amount of carbon nano-tube material may be, e.g., nano-grams, micron-grams, milli-grams, or possibly more. It may be desirable for the carbon nano-fibers to retain their metal (e.g., Fe, Ni, etc.) catalyst material. The small diameter of the carbon nano-tubes and small area at the end regions may be used to produce a large electric field from the interaction with the RF energy from the RF source 140. Another example of filamentary conductors that may be used as field defining conductors 150 are filaments of doped boron nitride or other suitable materials that can withstand the resulting environment, including heat, when the large electric field and resulting plasma are produced. An example of thin planar conductive sheets that may be used as field defining conductors 150 is, e.g., planar sheets of carbon commonly referred to as graphene. Graphene includes edges of small diameter that may be used to produce a large electric field from the interaction with the RF energy from the RF source 140.

It should be understood that the plasma lamp 100 may include additional components, such as a housing, optical elements, and circuitry, which are well known in the art.

FIG. 2 illustrates the plasma lamp 100 with an initial pulse of RF energy 210 from the RF source 140 that is directed into the capsule 110. The power density of the RF energy 210 and the physical geometry of the field defining conductors 150 are sufficient to create high energy electrical field to a partially ionized gas 220 that is in the vicinity of the field defining conductors 150. The power density of the RF energy 210 as well as the physical geometry of the field defining conductors 150 are dependent on factors such as the type of gas and pressure in the gaseous environment 120 and may be readily be determined by those skilled in the art in light of the present disclosure. By way of example, suitable RF energy 210 may be, e.g., 13.56 MHz to 2.45 GHz, and more specifically between approximately 400 MHz to 950 MHz.

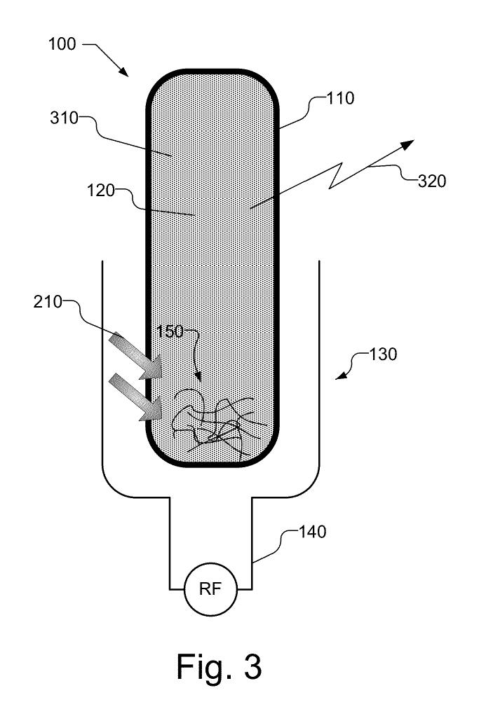

FIG. 3 illustrates the plasma lamp 100 with a sustained plasma 310 in the capsule 110 that produces light 320. The plasma 310 is created by the sustained application of the high power density RF energy 210 from the RF source 140 and the ionization of the gas in the vicinity of the high field regions surrounding the field defining conductors 150.

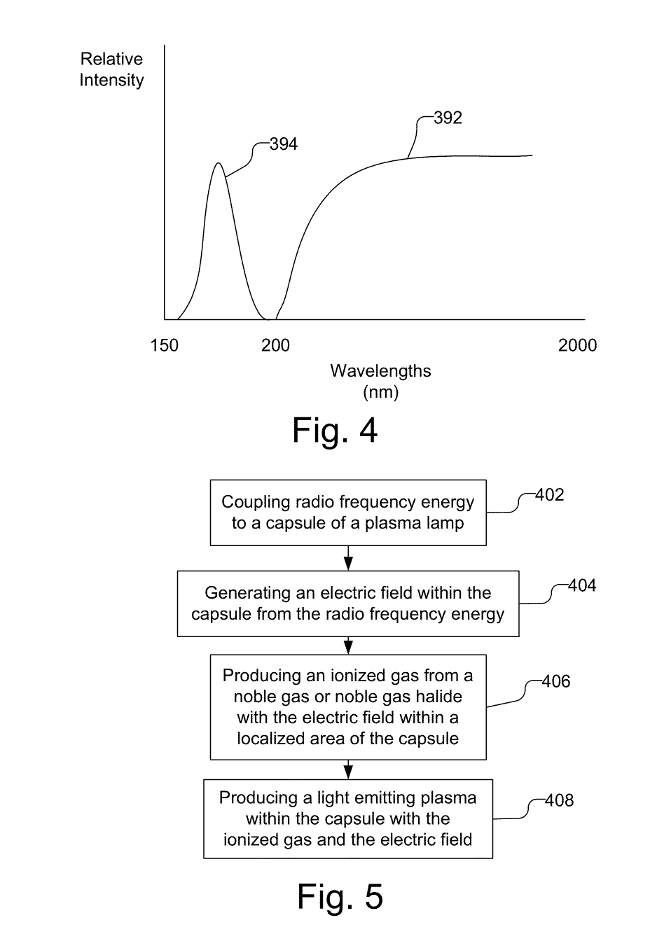

The use of noble gases or noble gas halides without the presence of metal salts in the plasma map is advantageous to produce light having a broad spectrum including visible light as well as UV components of less than 250 nm and more particularly less than 200 nm. FIG. 4, by way of example, graphically illustrates possible light output from plasma lamp 100. As illustrated, the light output from the plasma lamp 100 includes a first component 392 that is generally continuous spectra in the visible range and a second component 394 that is in the UV and/or DUV range, e.g., between 150 nm and 250 nm. By way of example, where the gaseous atmosphere 120 is Xe, which may have an at rest pressure of 4 bar (i.e., when no RF energy is applied), the first component 392 may be produced by the Xe gas, while the second component 394 in the DUV range may be produced by the excited dimer gas Xe₂, which emits at 172 nm. Other gases, such as Ar and Kr may be used, where Ar₂ and Kr₂ emit, e.g., 126 and 146 nm respectively. Additionally, gases such as ArF, KrCl, KrF, XeBr, XeCl, or XeF, emit at 193, 222, 248, 282, 308, 351 nm, respectively, and thus, may be used to produce the second component 394 if desired. Moreover, metal salts, and their corresponding limitation on the production of UV wavelengths, are eliminated in plasma lamp with the use of the ignition source 130 that includes the field defining conductors 150 within the capsule 110, which may be, e.g., 2 mg of carbon nano-tubes.

FIG. 5 is a flow chart of a method of producing a light emitting plasma in a plasma lamp. As illustrated, a radio frequency energy is coupled to a capsule of a plasma lamp (402). An electric field is generated within the capsule from the radio frequency energy (404). The electric field is generated in a localized area in the vicinity of the field defining conductors 150. An ionized gas from a noble or noble gas halide is produced with the electric field in a localized area of the capsule (406). A light emitting plasma is produced within the capsule with the ionized gas and the electric field (408).

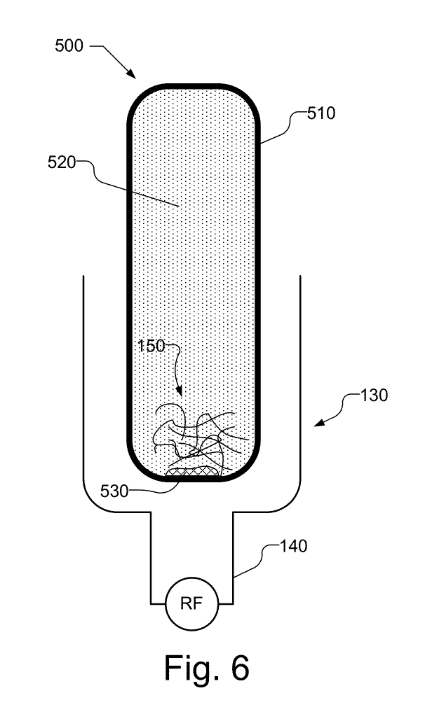

FIG. 6 illustrates a cross-sectional view of another embodiment of a plasma lamp 500, similar to plasma lamp 100 shown in FIG. 1, like designated elements being the same. Thus, plasma lamp 500 may include a capsule 510 and the ignition source 130, described in reference to FIG. 1, including a RF source 140 external to the capsule 110 and a plurality of field defining conductors 150 within the capsule 510. The plasma lamp 500 may include a gaseous environment 520 of, e.g., a noble gas, and may further include metal salts 530. The presence of metal salts prevents the plasma lamp 500 from producing UV or DUV wavelengths, but the use of the field defining conductors 150 advantageously reduces the strength of the RF field required for ionization of the filler gas, e.g., argon. Consequently, an overall improvement of the efficiency of the plasma lamp 500 (defined as the number of lumens generated vs. the applied power) may be achieved with respect to conventional plasma lamps.

Although the present invention is illustrated in connection with specific embodiments for instructional purposes, the present invention is not limited thereto. Various adaptations and modifications may be made without departing from the scope of the invention. Therefore, the spirit and scope of the appended claims should not be limited to the foregoing description.

What is claimed is:

1. A plasma lamp comprising:
a capsule;
a gas contained within the capsule, the gas comprising a noble gas or noble gas halide;
an ignition source configured to ionize the gas within the capsule to produce a light emitting plasma, the ignition source comprising:
field defining conductors within the capsule;
a radio frequency source external to the capsule, the radio frequency source being configured to produce radio frequency energy that is incident on the field defining conductors;
wherein the radio frequency source and the field defining conductors are configured so that the field defining conductors produce electric fields in response to the radio frequency energy from the radio frequency source and the electric field ionizes at least a portion of the gas.

2. The plasma lamp of claim 1, wherein the field defining conductors are electrical conductors with a radius of curvature that is sufficiently small to generate the localized electric field in response to the radio frequency energy.

3. The plasma lamp of claim 1, wherein the field defining conductors comprise at least one of filamentary conductors and planar conductive sheets.

4. The plasma lamp of claim 1, wherein the field defining conductors are carbon nano-tubes or carbon nano-fibers.

5. The plasma lamp of claim 1, wherein the field defining conductors are graphene.

6. The plasma lamp of claim 1, wherein the gas is Xenon.

7. The plasma lamp of claim 1, wherein the gas has a pressure of 0.5 bar or greater.

8. The plasma lamp of claim 1, wherein the gas has a pressure that is sufficient to produce a dimer molecule from the noble gas.

9. The plasma lamp of claim 1, wherein the light emitting plasma produces light having wavelengths in the visible range and the ultra-violet range between 150 nm and 250 nm.

10. The plasma lamp of claim 1, wherein the light emitting plasma produces light having wavelengths in the visible range and the ultra-violet range less than 200 nm.

11. The plasma lamp of claim 1, further comprising metal salts within the capsule.

12. A method comprising:
coupling radio frequency energy to a capsule of a plasma lamp;
generating an electric field from the radio frequency energy with field defining conductors within the capsule;
producing an ionized gas from a noble gas or noble gas halide within the capsule with the electric field within a localized area of the capsule with the electric field; and
producing a light emitting plasma within the capsule with the ionized gas and the electric field.

13. The method of claim 12, wherein are field defining conductors are electrical conductors with a radius of curvature that is sufficiently small to generate the electric field in the localized area in response to the radio frequency energy.

14. The method of claim 12, wherein are field defining conductors comprise at least one of filamentary conductors and planar conductive sheets.

15. The method of claim 12, wherein are field defining conductors are carbon nano-tubes or carbon nano-fibers.

16. The method of claim 12, wherein are field defining conductors are graphene.

17. The method of claim 12, wherein the noble gas or noble gas halide comprises Xenon.

18. The method of claim 12, further comprising holding the noble gas or noble gas halide at a pressure of 0.5 bar or greater.

19. The method of claim 12, further comprising holding the noble gas at a pressure that is sufficient to produce a dimer molecule from the noble gas.

20. The method of claim 12, further comprising emitting light form the capsule of the plasma lamp with wavelengths in the visible range and the ultra-violet range between 150 nm and 250 nm.

21. The method of claim 12, further comprising emitting light form the capsule of the plasma lamp with wavelengths in the visible range and the ultra-violet range less than 200 nm.

22. The method of claim 12, wherein metal salts are within the capsule.

23. A plasma lamp comprising:
a capsule;
a gas comprising xenon contained within the capsule, the gas held at a pressure of 0.5 bar or greater;
field defining conductors contained within the capsule, the field defining conductors being selected from a group comprising carbon nano-tubes, carbon nano-fibers and graphene, and being configured to produce a localized electrical field in response to radio frequency energy;
a radio frequency source external to the capsule, the radio frequency source being configured to produce radio frequency energy that is incident on the field defining conductors, wherein the localized electrical field produced by the field defining conductors ionizes at least a portion of the gas to produce a light emitting plasma that produces light that is emitted from the capsule having wavelengths in the visible range and less than 200 nm.

24. The plasma lamp of claim 23, wherein the field defining conductors are configured to produce the localized electrical field in response to the radio frequency by being electrical conductors with a radius of curvature that is sufficiently small to generate the localized electric field in response to the radio frequency energy.

25. The plasma lamp of claim 23, wherein the gas has a pressure that is sufficient to produce a dimer molecule from the xenon.
